(19) United States
(12) Patent Application Publication
(10) Pub. No.: US 2018/0265952 A1
(43) Pub. Date: Sep. 20, 2018

(54) HOLLOW SEAMLESS STEEL PIPE FOR SPRING

(71) Applicants: KABUSHIKI KAISHA KOBE SEIKO SHO (KOBE STEEL, LTD.), Kobe-shi, Hyogo (JP); SHINKO METAL PRODUCTS CO., LTD., Kitakyushu-shi, Fukuoka (JP)

(72) Inventors: Takuya KOCHI, Kobe-shi (JP); Hitoshi HATANO, Kobe-shi (JP); Kotaro TOYOTAKE, Kitakyushu-shi (JP)

(73) Assignees: Kabushiki Kaisha Kobe Seiko Sho (Kobe Steel, Ltd.), Kobe-shi, Hyogo (JP); Shinko Metal Products Co., Ltd., Kitakyushu-shi, Fukuoka (JP)

(21) Appl. No.: 15/541,534

(22) PCT Filed: Jan. 5, 2016
(86) PCT No.: PCT/JP2016/050134

§ 371 Date: Jul. 5, 2017

(30) Foreign Application Priority Data
Jan. 7, 2015 (JP) 2015-001710
Jan. 7, 2015 (JP) 2015-001711

(51) Int. Cl. C22C 38/34; C22C 38/46; C22C 38/50; C22C 38/04; C22C 38/06; C22C 38/00; C21D 8/10

(52) U.S. Cl. CPC C22C 38/34; C22C 38/46; C22C 38/50; F16F 1/021; C22C 38/06; C22C 38/001; C21D 8/105; C22C 38/04

(57) ABSTRACT

Provided is a hollow seamless steel pipe for a spring, including by mass %, C: 0.2 to 0.7%; Si: 0.5 to 3%; Mn: 0.1 to 2%; Cr: more than 0% and 3% or less; Al: more than 0% and 0.1% or less; P: more than 0% and 0.02% or less; S: more than 0% and 0.02% or less; and N: more than 0% and 0.02%: or less, with the balance being iron and inevitable impurities, wherein, an uneven thickness ratio calculated by formula (1) below is 7.0% or less.

Uneven Thickness Ratio=(Maximum Thickness−Minimum Thickness)/(Average Thickness)/2×100 (1)

### TECHNICAL FIELD

The present invention relates to a hollow seamless steel for a spring, and more particularly, to a hollow seamless steel pipe for a high-strength spring that is suitable for manufacturing a hollow steel suspension spring and the like to be used in automobiles and the like.

### BACKGROUND ART

In recent years, demand for reducing the weight of or enhancing the output of automobiles has risen in order to diminish exhaust gas and improve fuel efficiency. With this demand, suspension springs, such as suspension springs, valve springs and clutch springs, which are employed in suspensions, engines, clutches and the like, have been designed for high-stress. Thus, these springs have bean strengthened and have their diameters thinner, and thereby tend to be subjected to increased load stress. To cope with such tendency, higher performance steels for springs are strongly desired also in terms of fatigue resistance and settling resistance.

To achieve weight reduction while maintaining adequate fatigue resistance and settling resistance, a steel pipe without a welded seam made of hollow pipe-shaped steel (hereinafter referred to as a hollow seamless steel pipe) has been utilized as material for springs, in place of bar-shaped wire reds, previously used as material for springs, i.e., a solid wire rod. Various techniques have been hitherto proposed to manufacture this kind of hollow seamless steel pipe.

For example, Patent Document 1 proposes a technique in which raw material made of steel for springs is pierced by a Mannesmann piercer, which is a representative of a piercing mill, then subjected to elongation rolling by a mandrel mill, further reheated at 820 to 940° C. for 10 to 30 minute, followed by finish rolling. Patent Document 2 discloses a technique in which a cylindrical billet is subjected to a hot hydrostatic extrusion process to produce a seamless steel-pipe intermediate, after which the seamless steel-pipe intermediate is heated and then extended by at least one of a Pilger mill and a drawing process, for example, by a drawing, followed by heating the extended seamless steel-pipe intermediate. Patent Document 3 describes the manufacture of a seamless steel pipe by heating a hollow billet for extrusion, followed by hot extrusion, and then cold working and the like, in the same manner as Patent Document 2. Further, Patent Document 4 discloses a technique in which bar material produced by hot rolling is pierced with a gun drill and then subjected to cold rolling or drawing (cold working) thereby producing a seamless pipe. This technique avoids heating during the piercing or extrusion, thereby reducing decarburization.

Although those prior arts are intended to improve fatigue properties by reducing decarburization and flaws, higher fatigue strength is required at present than the conventional required level. Therefore, the techniques that have been previously proposed cannot satisfy the required fatigue strength at present, and are thus insufficient in terms of durability. In particular, in a higher stress region, the techniques that have already been proposed have limitations in terms of enhancing durability, and other factors also need to be considered.

### PRIOR ART DOCUMENT

### Patent Document

Patent Document 1: JP H01-247532 A

Patent Document 2: JP 4705456 B1

Patent Document 3: JP 2012-111979 A

Patent Document 4: JP 5324311 B1

### SUMMARY OF THE INVENTION

### Problems to be Solved by the Invention

The present invention has been made under the circumstances described above, and it is an object of the present invention to provide a hollow seamless steel pipe for a high-strength spring that enables a formed spring to ensure sufficient fatigue strength.

### Means for Solving the Problems

The present invention that achieves the above-mentioned object is characterized by reducing variations in the thickness of a steel pips. That is, a hollow seamless steel pipe for a spring according to the present invention includes by mass %:

C: 0.2 to 0.7%;

Si: 0.5 to 3%;

Mn: 0.1 to 2%;

Cr: more than 0% and 3% or less;

Al: more than 0% and 0.1% or less;

P: more than 0% and 0.02% or less;

S: more than 0% and 0.02% or less; and

N: more than 0% and 0.02% or less, with the balance being iron and inevitable imparities, wherein,

an uneven thickness ratio calculated by formula (1) below is 7.0% or less.

Uneven Thickness Ratio=(Maximum Thickness−Minimum Thickness)/(Average Thickness)/2×100 (1)

In the hollow seamless steel pipe for a spring according to the present invention, preferably, over an entire length of the steel pipe, a maximum value of the uneven thickness ratio calculated by formula (2) below is 7.0% or less; an inner-surface flaw depth is 50 μm or less; and an inner-surface total decarburization depth is 100 μm or less.

Uneven Thickness Ratio=(Maximum Thickness−Minimum Thickness)/((Maximum Thickness+Minimum Thickness)/2)/2×100 (2)

The hollow seamless steel pipe for a spring according to the present invention preferably further includes at least one of the following elements (a) to (f) as needed by mass %:

(a) B: more than 0% and 0.015% or less;

(b) one or more elements selected from a group consisting of V: more than 0% and 1% or less; Ti: more than 0% and 0.3% or less; and Nb: more than 0% and 0.3% or less;

(c) one or more elements selected from a group consisting of Ni: more than 0% and 3% or less; and Cu: more than 0% and 3% or less;

(d) Mo: more than 0% and 2% or less;

(e) one or more elements selected from a group consisting of Ca: more than 0% and 0.005% or less; Mg: more than 0% and 0.005% or less; and REM: more than and 0% and 0.02% or less; and

(f) one or more elements selected from a group consisting of Zr: more than 0% and 0.1% or less; Ta: more than 0% and 0.1% or less; and Hf: more than 0% and 0.1% or less.

### Effects of the Invention

The invention highly reduces an uneven thickness ratio, as an index of variations in the thickness of the steel pipe, to 7.0% or less, and thereby can provide the seamless steel pipe for a high-strength hollow spring that has high fatigue strength and excellent durability. The effects of the present invention can be remarkably exhibited, particularly, in a high stress range.

### BRIEF DESCRIPTION OF THE DRAWINGS

FIG. 1 is a graph showing the relationship between a ratio t/D of a thickness t to an outer diameter D of a steel pipe and a variation ratio of an inner-surface stress due to uneven thickness.

FIG. 2 is a graph showing the relationship between a ratio t/D of a thickness t to an outer diameter D of a steel pipe and a weight reduction ratio.

FIG. 3 is a graph obtained by plotting uneven thickness ratios for respective thicknesses when a thickness tolerance is 0.1 mm.

FIG. 4 is diagram showing the shape of a specimen used in a torsion fatigue test in Examples below.

FIG. 5 is a graph showing the relationship between the uneven thickness ratio and the durable number of times in the torsion fatigue test in Example 1 below.

FIG. 6 is a graph showing the relationship between the maximum value of the uneven thickness ratio over the entire length of a steel pipe and the durable number of times in the torsion fatigue test in Example 2 below.

### MODE FOR CARRYING OUT THE INVENTION

In a high-strength hollow spring, the improvement of the fatigue strength of its inner surface is an issue because shot peening cannot be applied thereto. Until now, suppression of the decarburization of the inner surface, reduction of flaws and the like have been studied. Meanwhile, inventors have diligently studied the influence of the thickness of a steel pipe as another influential factor. Consequently, it has been revealed that an uneven thickness ratio of the hollow steel pipe affects the fatigue strength.

In the prior art, such as those mentioned in the above-mentioned Patent Documents 1 to 4, the improvement of flaws and decarburization is a very important problem, and no consideration has been made on the uneven thickness ratio. However, as a result of the inventor's investigation by focusing on the uneven thickness ratio, it becomes evident that the influence of the uneven thickness ratio on the fatigue properties is significant, and particularly it is possible to improve the fatigue strength of the seamless steel pipe when the uneven thickness ratio is restricted to 7.0% or less. The uneven thickness ratio is preferably 5.0% or less, and more preferably 3.0% or less. The smaller the uneven thickness ratio, the better the fatigue properties of the steel pipe becomes. The lower limit of uneven thickness ratio is normally approximately 0.5%.

Furthermore, since the thickness of the steel pipe is not constant over its entire length the uneven thickness ratio is also difference, the suppression of variations in the thickness over the entire length is considered to be preferable in terms of obtaining the stable fatigue strength. That is, it has been revealed that in one preferred embodiment of the present invention, the maximum value of the uneven thickness ratio over the entire length of the steel pipe is restricted to 7.0% or less, thereby it is possible to improve the fatigue strength of the seamless steel pipe. The maximum value of the uneven thickness ratio over the entire length of the steel pipe is more preferably 5.0% or less, and even more preferably 3.0% or less. The smaller the uneven thickness ratio over the entire length of the steel pipe, the better the fatigue strength of the steel pipe becomes. The lower limit of uneven thickness ratio is normally approximately 0.5%.

In the present invention, the uneven thickness ratio is given by the following formula (1).

Uneven Thickness Ratio=(Maximum thickness−Minimum Thickness)/(Average Thickness)/2×100 (1)

The maximum thickness and the minimum thickness mean the maximum value and the minimum value of the thickness, respectively, measured at a plurality of sites on the same cross section, for example, at four sites every 90°. The average thickness means an average of the thicknesses measured at the above-mentioned plurality of sites.

The uneven thickness ratio over the entire length of the steel pipe is given by the following formula (2).

Uneven Thickness Ratio=(Maximum Thickness−Minimum Thickness)/((Maximum Thickness+Minimum Thickness)/2)/2×100 (2)

The maximum thickness and the minimum thickness mean the maximum value and the minimum value of the thickness, respectively, measured over an entire periphery of the steel pipe at one part, for example, by means of an ultrasonic probe or the like. The measurement of the uneven thickness ratio using formula (2) is performed over the entire length of the steel pipe. The obtained maximum value of the uneven thickness ratio is referred to as the “uneven thickness ratio over the entire length of the steel pipe”.

In the hollow seamless steel pipe for a spring according to the present invention, “uneven thickness ratio calculated by formula (1) is 7.0% or less” is expected that substantially, the uneven thickness ratio over the almost entire length of the steel pipe is 7.0% or less. Therefore, for example, on the cross section taken from an arbitrary part of a pipe end or the like, the uneven thickness ratio calculated by formula (1) is often 7.0% or less. For this reason, based on the result of one cross section, the uneven thickness ratio may be determined by formula (1).

In fact, the techniques mentioned in the above-mentioned Patent Documents 1 to 4 cannot be said to achieve good uneven thickness ratios. For example, in Patent Document 1, to manufacture a hollow steel pipe, Mannesmann piercing is used. The Mannesmann piercing achieves high productivity, but has lower gripping ability for material or tools during a hollowing process, that is, during piercing, as compared to other hollowing methods, easily causing the displacement of the material or tool, making it difficult to achieve good uneven thickness ratio. In particular, the steel for a high-strength spring has a high deformation resistance, and hence it is difficult to perform a high-accuracy process. In the techniques mentioned in Patent Documents 2 and 3, the machined hollow billet is subjected to the hot hydrostatic extrusion process. By the machining, the processing accuracy of the billet is high, and by the hydrostatic pressure, the billet is processed uniformly. Thus, the uneven thickness ratio can be improved more easily than in Patent Document 1. However, the methods disclosed in Patent Documents 2 and 3 cannot obtain the sufficient uneven thickness ratio in terms of the durability as shown in Examples to be mentioned later. Patent Document 4 employs gun drilling as the hollowing process. This method is also supposed to have a relatively good processing accuracy, but cannot obtain the sufficient uneven thickness ratio as shown in Examples to be mentioned later.

In one preferred embodiment of the present invention, the inner-surface flaws and the total decarburization are adjusted over the entire length of the pipe, in addition to the control of the above-mentioned uneven thickness ratio, thereby achieving more stable fatigue properties. The inner-surface flaw depth over the entire length of the pipe is preferably 50 μm or less, and the inner-surface total decarburization depth is preferably 100 μm or less.

The hollow seamless steel pipe as a target of the present invention has an outer diameter D of approximately 8 to 22 mm, a thickness t of approximately 0.8 to 7.7 mm, and a ratio t/D of the thickness t to the outer diameter D of approximately 0.10 to 0.35.

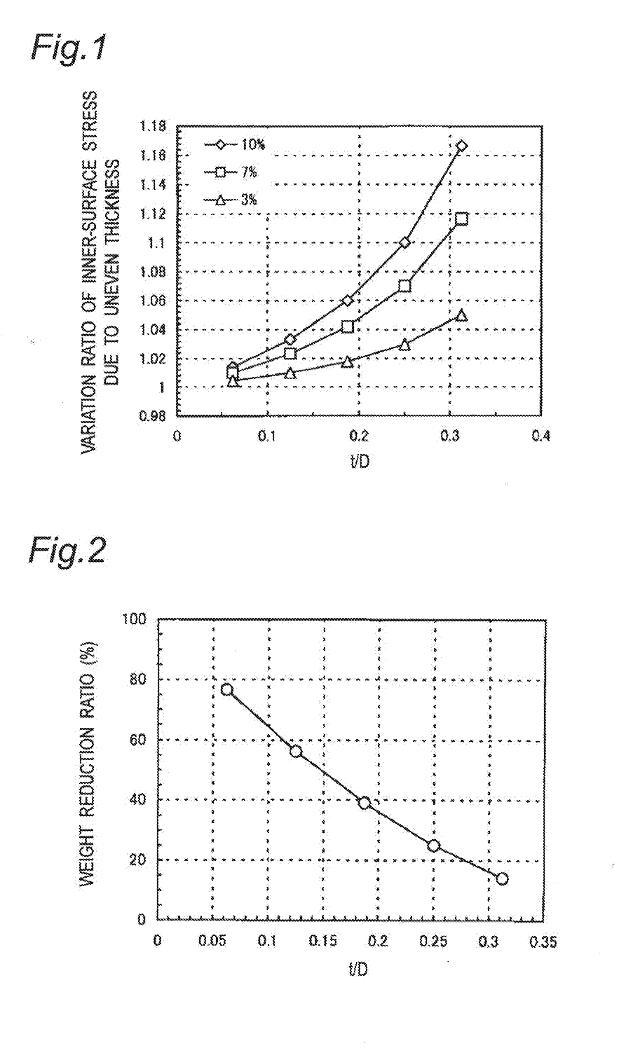

FIG. 1 is a graph obtained by plotting the relationship between the ratio t/D of the thickness t to the outer diameter D and a variation ratio of the inner-surface stress due to uneven thickness, for respective uneven thickness ratios of 3%, 7% and 10%. The variation ratio of the inner-surface stress is a value of σ2/σ1 where σ1 is an inner-surface stress in the absence of uneven thickness, and σ2 is an inner-surface stress in the presence of uneven thickness. As can also be seen from FIG. 1, when the uneven thickness occurs, a variation ratio of the inner-surface stress becomes higher as t/D is increased. When t/D is low, the variation ratio of the inner-surface stress varies a little even if the uneven thickness ratio changes. On the other hand, when t/D is high, the influence of the uneven thickness ratio on the variation ratio of the inner-surface stress becomes remarkable. Like the prior art, in a case where the uneven thickness ratio exceeds 7.0%, particularly, when t/D is 0.15 or more, the influence of the uneven thickness ratio on the variation ratio or the inner-surface stress becomes larger. That is, especially, when t/D is 0.15 or more, the present invention is very useful.

FIG. 2 is a graph showing the relationship between t/D and a weight reduction ratio. As can be seen from FIG. 2, as t/D is increased, the weight reduction ratio is decreased. The high-strength hollow spring is occasionally required to reduce its weight by 25% or more. Therefore, t/D is preferably set at 0.25 or less.

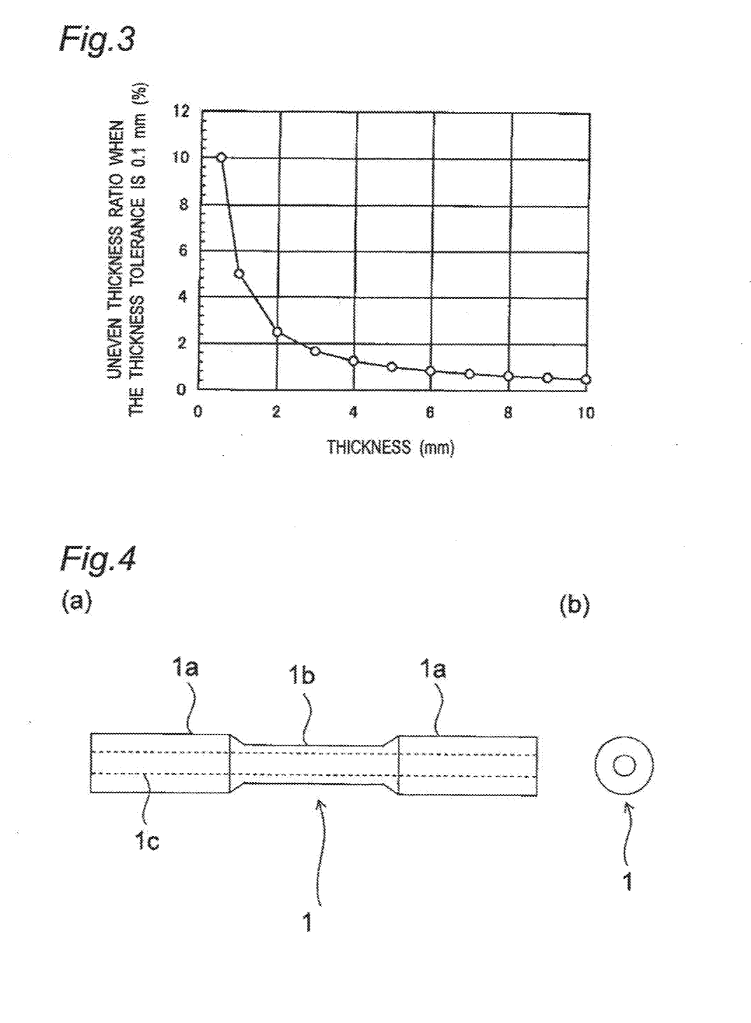

FIG. 3 is a graph obtained by plotting the uneven thickness ratios for respective thicknesses when a thickness tolerance, that is, a difference between the maximum thickness and the minimum thickness is 0.1 mm. As can be seen from FIG. 3, for example, when the thickness is 0.5 mm, even a tolerance of only 0.1 mm corresponds to 10% in terms of the uneven thickness ratio. In fact, in the prior art, the uneven thickness ratio exceeds 7.0%, which shows that it is very difficult to improve the uneven thickness ratio in a small thickness.

The inventors have studied manufacturing methods that restrict the uneven thickness ratio of a hollow seamless steel pipe to 7.0% or less, specifically, the method in which a hollow raw pipe is produced by the following method (1) or (2), and then subjected to cold-rolling, drawing process, annealing and the like, thereby a hollow seamless steel pipe is obtained.
(1) Method that involves obtaining a hollow billet from a raw billet by machining and then performing hot extrusion using the hollow billet
(2) Method that involves producing a steel bar from a raw billet by hot rolling and then hollowing the steel bar by gun drilling

In the method (1) of the hot extrusion, the dimension of the hollow billet is changed, thereby the uneven thickness ratio varies. By setting the inner diameter of the hollow billet at 38 mm, a raw pipe restricting the uneven thickness ratio of a seamless steel pipe finally obtained to 7.0% or less can be achieved. On the other hand, in the above-mentioned Patent Documents 2 and 3, the hollow billets have the inner diameters of 40 mm or 52 mm, so that the uneven thickness ratio of 7.0% or less cannot be achieved. In the method (2) that uses the gun drill, the uneven thickness ratio is varied by the dimension of the steel bar and the gun drilling dimension, and a steel bar of 40 mm in diameter is subjected to the gun drilling with a diameter of 20 mm, whereby a raw pipe restricting the uneven thickness ratio of a seamless steel pipe finally obtained to 7.0% or less can be achieved. Meanwhile, in the above-mentioned Patent Document 4, a steel bar of 25 mm in diameter is subjected to the gun drilling with a diameter of 12 mm, which fails to achieve the uneven thickness ratio of 7.0% or less

In the method (1), a heating temperature before the hot extrusion may be, for example, within a range from 1,000 to 1,100° C. In the method (2), a heating temperature in hot roiling may foe within a range from approximately 950 to 1,100° C., and the lowest rolling temperature may be within a range from 800 to 900° C. In the method (2), cooling may be performed from a temperature after hot rolling to a temperature between 650° C. and 750° C. at an average cooling rate between approximately 1.5° C./sec and 5° C./sec, and then subsequent cooling may be performed to 500° C. or lower at an average cooling rate between 0.3° C./sec and 1.0° C./sec. In either of the above-mentioned methods (1) and (2), the obtained raw pipe may be annealed, for example, at a temperature between 900° C. and 1,000° C. for 5 to 30 minutes, followed by cold-rolling and drawing, and then further annealing at a temperature between approximately 600° C. and 1,000° C.

In order to more surely reduce the uneven thickness ratio to 7% or less over the entire length, in the above-mentioned method (1), it is found that the reduction of a difference in the temperature in the longitudinal direction of the hollow billet, that is, of uneven heat is important in heating before the extrusion. The heating time before the hot extrusion is a relatively short time, and thereby uneven heat is likely to occur. For this reason, a soaking heat is applied before the heating, thereby it is possible to reduce the uneven heat distribution to decrease an uneven thickness ratio over the entire length. If the soaking heat temperature is extremely low or the soaking heat time is extremely short, the uneven thickness ratio is increased instead of reducing the uneven thickness ratio. If the soaking heat temperature is extremely high or the soaking heat time is extremely long, decarburization occurs, whereby the inner-surface total decarburization over the entire length cannot be restricted to 100 μm or less. Thus, the soaking heat temperature is preferably set at 900 to 950° C., and the soaking heat time is preferably set at 300 to 2,400 seconds. The soaking heat temperature is preferably 920° C. or higher and preferably 940° C. or lower. The soaking heat time is preferably 600 seconds or more, and more preferably 1,000 seconds or more. The soaking heat time is preferably 2,000 seconds or less, and more preferably 1,500 seconds or less.

Furthermore, the heating temperature before the extrusion is preferably 1,100° C. or higher. If the heating temperature is lower than 1,100° C., the frequency of occurrence of inner-surface flaws increases, thereby it is difficult to reduce the inner-surface flaw to 50 μm or less over the entire length. This is considered to be because, as the heating temperature becomes higher, the ductility of the steel during the extrusion becomes higher, and flaws are less likely to cause. The upper limit of the heating temperature is not particularly limited, but may be, for example, approximately 1,200° C.

The obtained raw pipe may be annealed, for example, at a temperature between 900° C. and 1,000° C. for 5 to 30 minutes, subjected to cold-rolling and drawing, and then further annealed at a temperature between approximately 900° C. and 1,000° C.

In the present invention, the method mentioned above can achieve the uneven thickness ratio of 7.0% or less. However, a method for manufacturing the hollow seamless steal pipe of the present invention is not limited to the method mentioned above.

Chemical components of the hollow seamless steel pipe for a high-strength spring in the present invention will be described below. In the present specification, all chemical components are represented by mass %.

### C: 0.2 to 0.7%

C is an element required to ensure the strength of a steel pipe. The C content needs to be 0.2% or more. The C content is preferably 0.30% or more, and more preferably 0.35% or more. However, an excessive C content makes it difficult to ensure the ductility of steel. Thus, the C content is set at 0.7% or less. The C content is preferably 0.65% or less, and more preferably 0.60% or less.

### Si: 0.5 to 3%

Si is an element effective in improving the settling resistance that is necessary for a spring. In order to obtain the settling resistance required for a spring of a target strength level in the present invention, the Si content needs to be 0.5% or more. The Si content is preferably 1.0% or more, and more preferably 1.5% or more. However, Si is also an element that promotes the decarburization. Thus, an excessive Si content promotes the formation of a decarburization layer on the surface of a steel. Consequently, to remove the decarburization layer, a peeling process is required, which, is disadvantageous in terms of manufacturing cost. For this reason, the Si content is set at 3% or less. The Si content is preferably 2.5% or less, and more preferably 2.2% or less.

### Mn: 0.1 to 2%

Mn is a useful element that is used as a deoxidizing element and can detoxify S by binding with S as a hazardous element in steel to form MnS. In order to effectively exhibit these effects, the Mn content needs to be 0.1% or more. The Mn content is preferably 0.15% or more, and more preferably 0.20% or more. However, an excessive Mn content forms segregation zones, thereby variations in the quality of material occur. Therefore, the Mn content is set at 2% or less. The Mn content is preferably 1.5% or less and more preferably 1.0% or less.

Cr: More than 0% and 3% or Less

Cr is an element effective in ensuring the strength after tempering and improving the corrosion resistance. In particular, Cr is an important element for suspension springs that require the high-level corrosion resistance. Such an effect becomes higher as the Cr content increases. Thus, in order to effectively exhibit this effect, the Cr content is preferably 0.2% or more, and more preferably 0.5% or more. However, an excessive Cr content easily generate a supercooled structure, and also makes Cr dense in cementite to reduce plastic deformation capacity, which leads to degradation of cold formability. Furthermore, an excessive Cr content easily creates Cr carbides that are different from cementite, thereby the balance between the strength and ductility deteriorates. For this reason, the Cr content is set at 3% or less. The Cr content is preferably 2.0% or less and more preferably 1.7% or less.

Al: More than 0% and 0.1% or Less;

Al is added to steel mainly as a deoxidizing element. Al detoxifies solid-solution N by binding with N to form AlN, and also contributes the refinement of the microstructure of steel. In particular, in order to fix the solid-solution N as AlN, the Al content preferably exceeds twice as much as the N content. The Al content is preferably 0.001% or more, more preferably 0.01% or more, and further preferably 0.025%; or more. However, Al is an element that promotes decarburization, like Si. Thus, in a steel containing a large content of Si, an added Al content needs to be restricted. Therefore, the Al content is set at 0.1% or less. The Al content is preferably 0.07% or less, and more preferably 0.05% or less.

P: More than 0% and 0.02% or Less

P is a harmful element that degrades the toughness or ductility of steel, and thus it is important to reduce the P content as much as possible. Thus, the P content is set at 0.02% or less. The P content is preferably 0.010% or less, and more preferably 0.008% or less. Since P is an impurity inevitably contained in steel, it is difficult to restrict the P content to 0% in terms of industrial production, and normally the P content is approximately 0.001%.

S: More than 0% and 0.02% or Less

S is a harmful element that degrades the toughness or ductility of steel, like P, and thus it is important to reduce the S content as much as possible. Thus, the S content is set at 0.02% or less. The S content is preferably 0.010% or less, and more preferably 0.008% or less. Since S is an impurity inevitably contained in steel, it is difficult to restrict the S content to 0% in terms of industrial production, and normally the S content is approximately 0.001%.

N: More than 0% and 0.02% or Less

N has the effect of refining the microstructure by forming a nitride in the presence of Al, Ti and the like. However, the presence of N in the solid-solution state degrades the toughness and the hydrogen embrittlement resistance of the steel. Thus, the N content is set at 0.02% or less. The N content is preferably 0.010% or less, and more preferably 0.005% or less. Since N is an element inevitably contained in steel, it is difficult to restrict the N content to 0% in terms of industrial production, and normally the N content is approximately 0.001%

The basic components of the seamless steel pipe of the present invention have been mentioned above, with the balance substantially being iron. Note that inevitable impurities are obviously allowed to be brought and contained in the steel, depending on the situations including raw materials, other materials, facilities and the like. Inevitable impurities as the balance as used herein means inevitable impurities other than the inevitably contained impurities whose contents are specified for each individual element as mentioned above. Furthermore, in the present invention, the steel may contain the following arbitrary elements as necessary.

B: More than 0% and 0.015% or Less

B has the effect of suppressing the fracture from prior austenite grain boundaries after quenching or tempering of the steel. In order to exhibit such an effect, the B content is preferably 0.001% or more, and more preferably 0.0015% or more. However, an excessive B content forms coarse boron carbides to deteriorate the properties of the steel, which also cause the occurrence of flaws in a rolled material. For this reason, the B content is preferably 0.015% or less. The B content is more preferably 0.010% or less and even more preferably 0.005% or less.

One or More Elements Selected from a Group Consisting of V: More than 0% and 1% or Less; Ti: More than 0% and 0.3% or Less; and Nb: More than 0.% and 0.3% or Less

Each of V, Ti and Nb has the function of detoxifying C, N and S, by binding with any one of C, N and S to form a carbide, a nitride a carbonitride (hereinafter referred to as a carbide-nitride), or a sulfide. The above-mentioned carbide-nitride also has the effect of refining the microstructure. Furthermore, V, Ti and Nb have the effect of improving the delayed fracture resistance. The V content is preferably 0.05% or more, more preferably 0.1% or more, and further preferably 0.13% or more. Each of the Ti content and Nb content is preferably 0.03% or more, more preferably 0.04% or more, and further preferably 0.05% or more.

However, an excessive V, Ti and Nb contents form coarse carbide-nitride to degrade the toughness and ductility in some cases. Thus, the V content is preferably set at 1% or less, the Ti content is preferably set at 0.3% or less, and the Nb content is preferably set at 0.3% or less. The V content is more preferably 0.5% or less, the Ti content is more preferably 0.1% or less, and the Nb content is more preferably 0.1% or less. Furthermore, in terms of cost reduction, the V content is preferably 0.3% or less, the Ti content is preferably 0.05% or less, and the Nb content is preferably 0.05% or less.

One or More Elements Selected from a Group Consisting of Ni: More than 0% and 3% or Less; Cu: and More than 0% and 3% or Less

When the cost reduction is taken into account, in order to refrain from adding Ni, the lower limit of Ni content is not particularly limited. In order to suppress the decarburization on the surface layer or to improve the corrosion resistance, the Ni content is preferably 0.1% or more. However, an excessive Ni content occasionally degrades the properties of steel due to the occurrence of supercooled structures in the rolled steel material or by the presence of residual austenite after quenching. For this reason, when Ni is contained in the steel, the upper limit of Ni content is preferably 3% or less. In terms of cost reduction, the Ni content is preferably 2.0% or less, and more preferably 1.0% or less.

Cu is an element effective in suppressing the decarburization on the surface layer and improving the corrosion resistance, like Ni. In order to effectively exhibit these effects, the Cu content is preferably 0.1% or more, further preferably 0.15% or more, and even more preferably 0.20% or more. However, an excessive Cu content occasionally causes the occurrence of supercooled structures or cracking during hot working. For this reason, when Cu is contained in the steel, the Cu content is preferably 3% or less. In terms of cost reduction, the Cu content is preferably 2.0% or less, and more preferably 1.0% or less.

Mo: More than 0% and 2% or Less

Mo is an element effective in ensuring the strength and improving the toughness after tempering. In order to exhibit these effects, the Mo content is preferably 0.1% or more, more preferably 0.2% or more, and further preferably 0.3% or more. However, an excessive Mo content degrades the toughness. For this reason, the Mo content is preferably 2% or less. The Mo content is more preferably 1% or less, and further preferably 0.5% or less.

One or More Elements Selected from a Group Consisting of Ca: More than 0% and 0.005% or Less; Mg: More than 0% and 0.0005% or Less; and REM More than 0% and 0.02% or Less

Each of Ca, Mg and REM (rare earth metal) has the effect of improving the toughness by forming a sulfide to prevent the elongation of MnS, and can be added depending on the required properties. In order to effectively exhibit these effects, each of the Ca content and the Mg content is preferably 0.0005% or more, more preferably 0.0010% or more, and further preferably 0.0015%; or more. The REM content is preferably 0.0005% or more, more preferably 0.0010% or more, and further preferably 0.0012% or more. However, an excessive Ca content, an excessive Mg content and an excessive REM content degrade the toughness. Thus, each of the Ca content and the Mg content is preferably 0.005% or less, more preferably 0.004% or less, and further preferably 0.003% or less. The REM content is preferably 0.02% or less, more preferably 0.01% or less, and further preferably 0.005% or less. In the present invention, REM includes 15 lanthanoid elements from La to Ln, and Sc and Y.

One or More Elements Selected from a Group Consisting of Zr: More than 0% and 0.1% or less; Ta: More than 0% and 0.1% or Less; and Hf: More than 0% and 0.1% or Less

Each of Zr, Ta and Hf has the effect of improving the toughness, by binding with N to form nitrides, thereby suppressing the growth of the austenite particle size during heating and then refining the final microstructure. In order to effectively exhibit these effects, the Zr content is preferably 0.01% or more, more preferably 0.03% or more, and further preferably 0.05% or more. Each of the Ta content and Hf content is preferably 0.01% or more, more preferably 0.02% or more, and further preferably 0.03% or more. However, an excessive Zr content, an excessive Ta content and an excessive Hf content coarsen nitrides, and thereby degrade the fatigue properties of the steel, and hence are not preferable. For this reason, the Zr content is preferably 0.1% or less, more preferably 0.09% or less, further preferably 0.05% or less, and particularly preferably 0.025% or less. Each of the Ta content and Hf content is preferably 0.1% or less, more preferably 0.08% or less, further preferably 0.05% or less, and particularly preferably 0.025% or less.

### EXAMPLES

Hereinafter, the present invention will be described more specifically with reference to examples. The present invention is not limited by the following examples, but can be naturally carried out by adding appropriate modifications thereto within a range that is suitable for the gist described above and below, and the modifications are included in the technical range of the present invention.

Molten steel with a chemical composition shown in Table 1 was smelted by a standard smelting method and was then subjected to casting and blooming, thereby a raw billet with a cross-sectional size of 155 mm×155 mm was produced. REM shown in Table 1 was added in the form of misch metal containing approximately 50% of La and approximately 25% of Ce.

TABLE 1

| | Chemical composition (% by mass) *Balance being iron and inevitable impurities | | | | | | | | | | | |
|---|---|---|---|---|---|---|---|---|---|---|---|---|
| Steel No. | C | Si | Mn | P | S | N | Al | Cr | Ni | Cu | Mo | V |
| A1 | 0.38 | 1.85 | 0.14 | 0.014 | 0.018 | 0.0029 | 0.0300 | 1.03 | 0.50 | 0.18 | | 0.172 |
| A2 | 0.40 | 2.30 | 1.00 | 0.005 | 0.002 | 0.0020 | 0.0312 | 1.29 | 0.40 | 0.30 | | |
| A3 | 0.41 | 2.10 | 0.75 | 0.002 | 0.005 | 0.0032 | 0.0285 | 1.60 | 0.37 | 0.28 | | |
| A4 | 0.43 | 1.88 | 0.20 | 0.007 | 0.007 | 0.0033 | 0.0277 | 1.10 | 0.65 | 0.20 | | 0.150 |
| A5 | 0.44 | 1.65 | 0.38 | 0.008 | 0.010 | 0.0051 | 0.0250 | 0.80 | 0.50 | 0.15 | | |
| A6 | 0.44 | 1.70 | 0.13 | 0.010 | 0.005 | 0.0028 | 0.0020 | 0.98 | 0.26 | 0.24 | | 0.131 |
| A7 | 0.45 | 1.79 | 0.25 | 0.013 | 0.009 | 0.0030 | 0.0289 | 0.92 | 0.13 | 0.57 | 0.50 | |
| A8 | 0.47 | 1.98 | 0.84 | 0.006 | 0.012 | 0.0049 | 0.0340 | 0.13 | 0.20 | 0.11 | | 0.189 |
| A9 | 0.55 | 1.40 | 0.73 | 0.017 | 0.018 | 0.0041 | 0.0410 | 0.70 | | | | |
| A10 | 0.62 | 2.00 | 0.65 | 0.023 | 0.023 | 0.0071 | 0.0389 | 0.15 | | | | |

| | Chemical composition (% by mass) | | | | | | | | |
|---|---|---|---|---|---|---|---|---|---|
| | *Balance being iron and inevitable impurities | | | | | | | | |
| Steel No. | Ti | Nb | Zr | Ta | Hf | Mg | Ca | REM | B |
| A1 | 0.062 | | | | | | | | |
| A2 | 0.177 | | | 0.031 | | | | | 0.0050 |
| A3 | 0.122 | | | | 0.035 | 0.0018 | | | 0.0015 |
| A4 | 0.071 | | | | | | | | |
| A5 | 0.048 | 0.077 | | | | | 0.0019 | | |
| A6 | 0.081 | | 0.091 | | | | | 0.0012 | |
| A7 | | | | | | | | | |
| A8 | 0.095 | | | | | | | | |
| A9 | | | | | | | | | |
| A10 | | | | | | | | | |

In a method that included hot-extrusion by using a hollow billet, a cylindrical hollow billet was produced by machining from the above-mentioned raw billet, and then the hollow billet was subjected to hot extrusion, thereby a raw pipe was obtained. Then, the raw pipe was subjected to cold-rolling and drawing process, thereby a hollow seamless steel pipe with an outer diameter of 16 mm, an inner diameter of 8 mm and a length of 3,000 mm was produced. The detailed manufacturing methods are shown in A to D in Table 2.

In a method that included producing a steel bar by hot rolling, followed by hollowing through gun drilling, the above-mentioned raw billet was subjected to hot rolling on conditions shown as any one of conditions E and F in Table 2, thereby a steel bar was obtained, which was then subjected to gun drilling to be hollowed, thus a raw pipe was obtained. Then, the raw pipe was subjected to cold-rolling and drawing process, thereby a hollow seamless steel pipe with an outer diameter of 16 mm, an inner diameter of 8 mm, and a length of 3,000 mm was produced.

C in table 2 is a manufacturing method disclosed in the above-mentioned Patent Document 3; D is the method disclosed in the above-mentioned Patent Document 2; and E is the method disclosed in the above-mentioned Patent Document 4.

TABLE 2

| Manufacturing | |
|---|---|
| Condition | Manufacturing Method |
| A | A raw billet with a cross-sectional shape having |
| | a size of 155 mm × 155 mm wad subjected to hot |
| | forging and cutting, thereby a cylindrical |
| | hollow billet with an outer diameter of 143 mm |
| | and an inner diameter of 38 mm was produced. The |
| | hollow billet was subjected to hot hydrostatic |
| | extrusion by setting a heating temperature at |
| | a temperature between 1,000° C. and 1,100° C., |
| | thereby a hollow raw pipe with outer diameter |
| | of 54 mm × inner diameter of 38 mm was obtained. |
| | The hollow raw pipe was annealed at 950° C. for |
| | 10 minutes and then repeatedly subjected to |
| | rolling and drawing, thus a formed pipe with |
| | outer diameter of 16 mm × inner diameter of 8 mm × |
| | length of 3,000 mm was produced. After the |
| | final drawing process, the drawn pipe was |
| | annealed at 950° C. for 10 minutes, thereby a |
| | hollow seamless steel pipe was produced. |
| B | A raw billet with a cross-sectional shape having |
| | a size of 155 mm × 155 mm was subjected to hot |
| | forging and cutting, thereby a cylindrical |
| | hollow billet with an outer diameter of 143 mm |
| | and an inner diameter of 52 mm was produced. The |
| | hollow billet was subjected to hot hydrostatic |
| | extrusion by setting a heating temperature at |
| | 1,100° C., thereby a hollow raw pipe with outer |
| | diameter of 54 mm × inner diameter of 38 mm was |
| | obtained. The hollow raw pipe was annealed at |
| | 950° C. for 10 minutes and then repeatedly |
| | subjected to rolling and drawing, thus a formed |
| | pipe with outer diameter of 16 mm × inner |
| | diameter of 8 mm × length of 3,000 mm was |
| | produced. After the final drawing process, the |
| | drawn pipe was annealed at 950° C. for 10 minutes, |
| | thereby a hollow seamless steel pipe was |
| | produced. |
| C | A raw billet with a cross-sectional shape having |
| | a size of 155 mm × 155 mm was subjected to hot |
| | forging and cutting, thereby a cylindrical |
| | hollow billet with an outer diameter of 143 mm |
| | and an inner diameter of 40 mm was produced. The |
| | hollow billet was subjected to hot hydrostatic |
| | extrusion by setting a heating temperature at |
| | 1,000° C., thereby a hollow raw pipe with outer |
| | diameter of 54 mm × inner diameter of 38 mm was |
| | obtained. The hollow raw pipe was annealed at |
| | 950° C. for 10 minutes and then repeatedly |
| | subjected to rolling and drawing, thus a formed |
| | pipe with outer diameter of 16 mm × inner |
| | diameter of 8 mm × length of 3,000 mm was |
| | produced. After the final drawing process, the |
| | drawn pipe was annealed at 950° C. for 10 minutes, |
| | thereby a hollow seamless steel pipe was |
| | produced. |
| D | A raw billet with a cross-sectional shape having |
| | a size of 155 mm × 155 mm was subjected to hot |
| | forging and cutting, thereby a cylindrical |
| | hollow billet with an outer diameter of 143 mm |
| | and an inner diameter of 52 mm was produced. The |
| | hollow billet was subjected to hot hydrostatic |
| | extrusion by setting a heating temperature at |
| | 1,100° C., thereby a hollow raw pipe with outer |
| | diameter of 54 mm × inner diameter of 38 mm was |
| | obtained. The hollow raw pipe was annealed at |
| | 680° C. for 16 hours and then repeatedly subjected |
| | to rolling and drawing, thus a formed pipe with |
| | outer diameter of 16 mm × inner diameter of 8 mm × |
| | length 3,000 mm was produced. After the |
| | final drawing process, the drawn pipe was |
| | annealed at 750° C. for 30 minutes, thereby a |
| | hollow seamless steel pipe was produced. |
| E | A raw billet with a cross-sectional shape having |
| | a size of 155 mm × 155 mm was subjected to hot |
| | rolling and cooling, thereby a steel bar with |
| | a diameter of 25 mm was produced. In the hot |
| | rolling, a heating temperature was set at |
| | 1,000° C., and a minimum rolling temperature was |
| | set at 850° C. In the cooling after the hot |
| | rolling, an average cooling rate was set at |
| | 2° C./sec to 720° C., and at 0.5° C./sec to 500° C. The |
| | obtained steel bar had its inside pierced by a |
| | gun drill to form a hole with an inner diameter |
| | of 12 mm. Then, cold-rolling was performed on |
| | the bar, thus a formed pipe with outer diameter |
| | of 16 mm × inner diameter of 8 mm and length of |
| | 3,000 mm was produced. Furthermore, the formed |
| | pipe was annealed at 650° C., thereby a hollow |
| | seamless steel pipe was produced. |
| F | A raw billet with a cross-sectional shape having |
| | a size of 155 mm × 155 mm was subjected to hot |
| | rolling and cooling, thereby a steel bar with |
| | a diameter of 40 mm was produced. In the hot |
| | rolling, a heating temperature was set at |
| | 1,000° C., and a minimum rolling temperature was |
| | set at 850° C. In the cooling after the hot |
| | rolling, an average cooling rate was set at |
| | 2° C./sec to 720° C., and at 0.5° C./sec to 500° C. The |
| | obtained steel bar had its inside pierced by a |
| | gun drill to form a hole with an inner diameter |
| | of 20 mm. Then, cold-rolling was performed on |
| | the bar, thus producing a formed pipe with outer |
| | diameter of 16 mm × inner diameter of 8 mm and |
| | length of 3,000 mm. Furthermore, the formed |
| | pipe was annealed at 650° C., thereby a hollow |
| | seamless steel pipe was produced. |

The hollow seamless steel pipes obtained in this way were measured and evaluated in the following ways.

### (1) Measurement of Uneven Thickness Ratio

The thickness of a pipe end part of the above-mentioned hollow seamless steel pipe was measured at four sites every 90° by using a micrometer, and the uneven thickness ratio was calculated by formula (1) below.

Uneven Thickness Ratio=(Maximum Thickness−Minimum Thickness)/(Average Thickness)/2×100 (1)

### (2) Evaluation of Fatigue Properties

The hollow seamless steel pipe was subjected to quenching and tempering on the following conditions.

Quenching conditions: after holding the steel pipe at 925° C. for 10 minutes, the steel pipe is oil-cooled.

Tempering conditions: after holding the steel pipe at 390° C. for 40 minutes, the steel pipe is water-cooled.

The hollow seamless steel pipe obtained alter the quenching and tempering was formed into a cylindrical test specimen 1 shown in FIGS. 4. FIG. 4(a) is a front view, and FIG. 4(b) is a side view showing an end surface of the test specimen. A torsion fatigue test was performed by using the cylindrical test specimen 1. In the test specimen, its inner diameter was approximately 8.0 mm; the outer diameter of its restrained part 1a was 16 mm; the outer diameter of its center part 1b was 12 mm; and a load stress, represented by a stress applied at the outer surface of the center part, was 550±375 MPa. The durable number of times was defined and measured as the number of times to failure. For test specimens that did not lead to failure even after 10⁶ times, the test was stopped at that time.

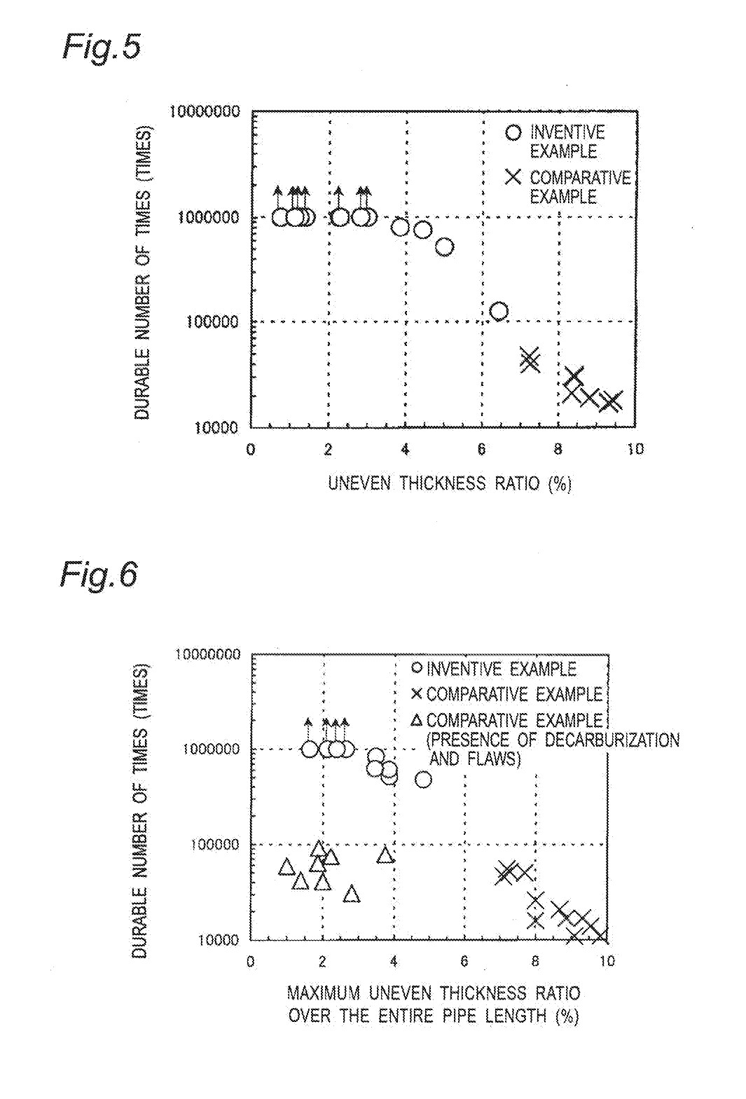

The results are shown in Table 3 and FIG. 5. FIG. 5 is a graph showing the relationship between the uneven thickness ratio and the durable number of times in the torsion fatigue test in Inventive Examples of the present invention and Comparative Examples.

TABLE 3

| | | | Heating | | | | | | |
|---|---|---|---|---|---|---|---|---|---|
| | | | temperature | | Steel pipe | | | | |
| | | | before hot | Heating | Maximum | Minimum | Average | Uneven | |
| | | Manufacturing | extrusion | time | thickness | thickness | thickness | thickness | Durable number of times in |
| No. | Steel No. | condition | (° C.) | (sec) | (mm) | (mm) | (mm) | ratio (%) | torsion fatigue test (times) |
| 1 | A1 | A | 1,100 | 60 | 4.12 | 3.88 | 4.00 | 3.0 | Stopped in one million times |
| 2 | A1 | B | 1,100 | 60 | 4.28 | 3.62 | 3.95 | 8.4 | 21,000 |
| 3 | A1 | C | 1,000 | 60 | 4.28 | 3.70 | 3.99 | 7.3 | 40,000 |
| 4 | A1 | D | 1,100 | 60 | 4.38 | 3.67 | 4.03 | 8.8 | 19,000 |
| 5 | A1 | E | — | — | 4.35 | 3.60 | 3.98 | 9.4 | 18,000 |
| 6 | A1 | F | — | — | 4.20 | 3.80 | 4.00 | 5.0 | 519,000 |
| 7 | A2 | A | 1,050 | 60 | 4.01 | 3.90 | 3.96 | 1.4 | Stopped in one million times |
| 8 | A3 | A | 1,000 | 60 | 4.08 | 3.98 | 4.03 | 1.2 | Stopped in one million times |
| 9 | A4 | A | 1,000 | 60 | 4.05 | 3.99 | 4.02 | 0.7 | Stopped in one million times |
| 10 | A4 | B | 1,100 | 60 | 4.38 | 3.70 | 4.04 | 8.4 | 30,000 |
| 11 | A4 | C | 1,000 | 60 | 4.30 | 3.72 | 4.01 | 7.2 | 47,000 |
| 12 | A4 | D | 1,100 | 60 | 4.40 | 3.65 | 4.03 | 9.3 | 17,000 |
| 13 | A4 | E | — | — | 4.32 | 3.65 | 3.99 | 8.4 | 31,000 |
| 14 | A4 | F | — | — | 4.30 | 3.78 | 4.04 | 6.4 | 125,000 |
| 15 | A5 | A | 1,000 | 60 | 4.10 | 4.01 | 4.06 | 1.1 | Stopped in one million times |
| 16 | A6 | A | 1,000 | 60 | 4.08 | 3.90 | 3.99 | 2.3 | Stopped in one million times |
| 17 | A7 | A | 1,100 | 60 | 4.02 | 3.80 | 3.91 | 2.8 | Stopped in one million times |
| 18 | A8 | A | 1,100 | 60 | 4.05 | 3.75 | 3.90 | 3.8 | 801,000 |
| 19 | A9 | A | 1,000 | 60 | 4.03 | 3.85 | 3.94 | 2.3 | Stopped in one million times |
| 20 | A10 | A | 1,100 | 60 | 4.24 | 3.88 | 4.06 | 4.4 | 753,000 |

Tests Nos. 1, 6 to 9 and 14 to 20 shown in Table 3 having an uneven thickness ratio of 7.0% or less corresponded to circle marks in FIG. 5 and achieved 10⁵ or more times of the durable number of times in the torsion fatigue test. Thus, the results of these tests exhibited good durability. In particular, the tests Nos. 1, 6 to 9 and 15 to 20 having the uneven thickness ratio of 5.0% or less achieved 5×10⁵ or more times of the durable number of times, and further the tests Nos. 1, to 9, 15 to 17 and 19 having the uneven thickness ratio of 3.0% or less achieved 10⁶ or more times of the durable number of times. On the other hand, tests Nos. 2 to 5 and 10 to 13 having the uneven thickness ratio exceeding 7.0% had less than 10⁵ times of durable number of times as illustrated by X marks in FIG. 5. Among them, tests Nos. 3 to 5 and 11 to 13 were examples in which the hollow seamless steel pipes were manufactured by any one of the manufacturing conditions C to E corresponding to the above-mentioned Patent Documents 2 to 4, resulting in the uneven thickness ratio exceeding 7.0%.

### 2. Example 2

Molten steel, with a chemical composition shown in Table 1 of Example 1 was smelted by a normal smelting method and was then subjected to casting and blooming, thereby a raw billet with a cross-sectional size of 155 mm×155 mm was produced. REM shown in Table 1 was added in the form of mischmetal containing approximately 50% of La and approximately 25% of Ce.

By any one of the conditions A to G described in Table 4, a hollow raw pipe was obtained from each raw billet and then subjected to cold-rolling and drawing process, thereby a hollow seamless steel pipe with an outer diameter of 16 mm, an inner diameter of 8 mm and a length of 3,000 mm was produced. Each of the conditions A to F is a method in which a hollow billet was obtained by machining a raw billet, and then subjected to hot extrusion, thereby a hollow raw pipe is obtained. The condition G is a method in which a steel bar was obtained from a raw billet by hot rolling, and then subjected to gun drilling, thereby a hollow raw pipe is obtained. The condition E is the manufacturing method disclosed in the above-mentioned Patent Document 3; F is the method disclosed in above-mentioned Patent Document 2; and G is the method disclosed in the above-mentioned Patent Document 4.

TABLE 4

| Manufacturing | |
|---|---|
| Condition | Manufacturing Method |
| A | A raw billet with a cross-sectional shape having |
| | a size of 155 mm × 155 mm was subjected to hot |
| | forging and cutting, thereby a cylindrical |
| | hollow billet with an outer diameter of 143 mm |
| | and an inner diameter of 38 mm was produced. The |
| | hollow billet was subjected to hot hydrostatic |
| | extrusion by performing a soaking heat at a |
| | temperature between 900° C. and 950° C. for 300 to |
| | 2400 seconds, and further by setting a heating |
| | temperature before extrusion in a range of 1,000 |
| | to 1,200° C. thereby a hollow raw pipe with outer |
| | diameter of 54 mm × inner diameter of 38 mm was |
| | obtained. The hollow raw pipe was annealed at |
| | 950° C. for 10 minutes and then repeatedly |
| | subjected to rolling and drawing, thus a formed |
| | pipe with outer diameter of 16 mm × inner diameter |
| | of 8 mm × length of 3,000 mm was produced. After |
| | the final drawing process, the drawn pipe was |
| | annealed at 950° C. for 10 minutes, thereby a hollow |
| | seamless steel pipe was produced. |
| B | A raw billet with a cross-sectional shape having |
| | a size of 155 mm × 155 mm was subjected to hot |
| | forging and cutting, thereby a cylindrical |
| | hollow billet with an outer diameter of 143 mm |
| | and an inner diameter of 38 mm was produced. The |
| | hollow billet was subjected to hot hydrostatic |
| | extrusion by performing a soaking heat at a |
| | temperature of 900° C. for 10 seconds or 3,600 |
| | seconds, and further by setting a heating |
| | temperature before extrusion in a range of 1,000 |
| | to 1,100° C., thereby a hollow raw pipe with outer |
| | diameter of 54 mm × inner diameter of 38 mm was |
| | obtained. The hollow raw pipe was annealed at |
| | 950° C., for 10 minutes and then repeatedly |
| | subjected to rolling and drawing, thus a formed |
| | pipe with outer diameter of 16 mm × inner diameter |
| | of 8 mm × length of 3,000 mm was produced. After |
| | the final drawing process, the drawn pipe was |
| | annealed at 950° C. for 10 minutes, thereby a hollow |
| | seamless steel pipe was produced. |
| C | A raw billet with a cross-sectional shape having |
| | a size of 155 mm × 155 mm was subjected to hot |
| | forging and cutting, thereby a cylindrical |
| | hollow billet with and outer diameter of 143 mm |
| | and an inner diameter of 38 mm was produced. The |
| | hollow billet was subjected to hot hydrostatic |
| | extrusion without performing a soaking heat by |
| | setting a heating temperature before extrusion |
| | in a range of 1,000 to 1,100° C., thereby a hollow |
| | raw pipe with outer diameter of 54 mm × inner |
| | diameter of 38 mm was obtained. The hollow raw |
| | pipe was annealed at 950° C. for 10 minutes and then |
| | repeatedly subjected to rolling and drawing, |
| | thus a formed pipe with outer diameter of 16 mm × |
| | inner diameter of 8 mm × length of 3,000 mm was |
| | produced. After the final drawing process, the |
| | drawn pipe was annealed at 950° C. for 10 minutes, |
| | thereby a hollow seamless steel pipe was |
| | produced. |
| D | A raw billet with a cross-sectional shape having |
| | a size of 155 mm × 155 mm was subjected to |
| | hot-forging and cutting, thereby a cylindrical |
| | hollow billet with an outer diameter of 143 mm |
| | and an inner diameter of 52 mm was produced. The |
| | hollow billet was subjected to hot hydrostatic |
| | extrusion without performing a soaking heat by |
| | setting a heating temperature before extrusion |
| | at 1,100° C., thereby a hollow raw pipe with outer |
| | diameter of 54 mm × inner diameter of 38 mm was |
| | obtained. The hollow raw pipe was annealed at |
| | 950° C. for 10 minutes and then repeatedly |
| | subjected to rolling and drawing, thus a formed |
| | pipe with outer diameter of 16 mm × inner diameter |
| | of 8 mm × length of 3,000 mm was produced. After |
| | the final drawing process, the drawn pipe was |
| | annealed at 950° C. for 10 minutes, thereby a hollow |
| | seamless steel pipe was produced. |
| E | A raw billet with a cross-sectional shape having |
| | a size of 155 mm × 155 mm was subjected to |
| | hot-forging and cutting, thereby a cylindrical |
| | hollow billet with an outer diameter of 143 mm |
| | and an inner diameter of 40 mm was produced. The |
| | hollow billet was subjected to hot hydrostatic |
| | extrusion without performing a soaking heat |
| | treatment by setting a heating temperature |
| | before extrusion at 1,000° C. thereby a hollow raw |
| | pipe with outer diameter of 54 mm × inner diameter |
| | of 38 mm was obtained. The hollow raw pipe was |
| | annealed at 950° C. for 10 minutes and then |
| | repeatedly subjected to rolling and drawing, |
| | thus a formed pipe with outer diameter of 16 mm × |
| | inner diameter of 8 mm × length of 3,000 mm was |
| | produced. After the final drawing process, the |
| | drawn pipe was annealed at 950° C. for 10 minutes, |
| | thereby a hollow seamless steel pipe was |
| | produced. |
| F | A raw billet with a cross-sectional shape having |
| | a size of 155 mm × 155 mm was subjected to |
| | hot-forging and cutting, thereby a cylindrical |
| | hollow billet with an outer diameter of 143 mm |
| | and an inner diameter of 52 mm was produced. The |
| | hollow billet was subjected to hot hydrostatic |
| | extrusion without performing a soaking heat |
| | treatment by setting a heating temperature |
| | before extrusion at 1,100° C. thereby a hollow raw |
| | pipe with outer diameter of 54 mm × inner diameter |
| | of 38 mm was obtained. The hollow raw pipe was |
| | annealed at 680° C. for 16 hours and then repeatedly |
| | subjected to rolling and drawing, thus a formed |
| | pipe with outer diameter of 16 mm × inner diameter |
| | of 8 mm × length of 3,000 mm was produced. After |
| | the final drawing process, the drawn pipe was |
| | annealed at 750° C. for 30 minutes, thereby |
| | eventually producing a hollow seamless steel |
| | pipe. |
| G | A raw billet with a cross-sectional shape having |
| | a size of 155 mm × 155 mm was subjected to hot |
| | rolling and cooling, thereby a steel bar with a |
| | diameter of 25 mm was produced. In the hot |
| | rolling, a heating temperature was set at |
| | 1,000° C., and a minimum rolling temperature was |
| | set at 850° C. In the cooling after the hot |
| | rolling, an average cooling rate was set at |
| | 2° C./sec to 720° C., and 0.5° C./sec to 500° C. The |
| | obtained steel bar had its inside pierced by a |
| | gun drill to form a hole with an inner diameter |
| | of 12 mm. Then, cold-rolling was performed on |
| | the bar, thus a formed pipe with outer diameter |
| | of 16 mm × inner diameter of 8 mm and length of |
| | 3,000 mm was produced. Furthermore, the formed |
| | pipe was annealed at 650° C., thereby a hollow |
| | seamless steel pipe was produced. |

The hollow seamless steel pipes obtained in this way were measured and evaluated in the following ways.

### (1) Measurement of Uneven Thickness Ratio

The thickness of the hollow seamless steel pipe was measured in the following way.

### (1-a) Measurement of Thickness of Pipe End Part

The thickness of a pipe end part of each hollow seamless steel pipe finally obtained was measured at four sites every 90° by using a micrometer, and the uneven thickness ratio was calculated by formula (1) below.

Uneven Thickness Ratio=(Maximum Thickness−Minimum Thickness)/(Average Thickness)/2×100 (1)

### (1-b) Measurement of Thickness of Pipe Over Its Entire Length

The hollow seamless steel pipe was scanned in the longitudinal direction of the steel pipe by an ultrasonic probe in contact with the outer surface of the steel pipe, while rotating the steel pipe, whereby the thickness of the pipe was measured over its entire periphery and length. Based on the obtained measurement results of the thicknesses, the maximum thickness and minimum thickness obtained by moving the probe along the entire periphery of the steel pipe were used to calculate the uneven thickness ratio by the following formula (2). Likewise, over the entire length of the pipe, the uneven thickness ratios were measured to thereby determine the maximum uneven thickness ratio.

At this time, in order to enable the examination over the entire length and periphery of the pipe without exception, the scanning speed of the ultrasonic sensor, the rotational rate of the pipe, and the measurement pitch were adjusted. In order to ensure the quantitativeness, the calibration for ultrasonic measurement was performed before the examination. Specifically, the end part of the steel pipe was measured with the micrometer, and based on the measurement result, the calibration for ultrasonic measurement was performed.

Uneven Thickness Ratio=(Maximum Thickness−Minimum Thickness)/(Maximum Thickness+Minimum Thickness)/2)2×100 (2)

### (2) Measurement of Inner-Surface Flaws

Like the measurement of the thickness over the entire length as described in the above (1-b), the inner-surface flaw depth over entire periphery and length of the steel pipe were measured with the ultrasonic probe. In order to ensure the quantitativeness, a standard pipe that had an artificial flaw, whose size was known, on its inner surface was used and examined offline, thereby the calibration was performed.

### (3) Measurement of Inner-Surface Total Decarburization

The decarburization was evaluated by observing the cross section of the steel pipe. In order to evaluate variations in the decarburization in the longitudinal direction, the steel pipe was divided into ten parts, whereby ten samples were taken. The cross-sectional surface of each sample was embedded in resin and subjected to mirror polishing, followed by etching with nital etchant, and then observed using an optical microscope at 200 magnifications. The maximum depths of the inner-surface total decarburization depths of ten samples were measured.

### (4) Evaluation of Fatigue Properties

The hollow seamless steel pipe was subjected to quenching and tempering on the following conditions.
Quenching conditions: after holding the steel pipe at 925° C. for 10 minutes, the steel pipe was oil-cooled.
Tempering conditions: after holding the steel pipe at 390° C. for 40 minutes, the steel pipe was water-cooled.

The hollow seamless steel pipe obtained after the quenching and tempering was processed into a cylindrical test specimen 1 shown in FIGS. 4. FIG. 4(a) is a front view, and FIG. 4(b) is a side view showing an end surface of the test specimen. Ten cylindrical test specimens 1 were prepared for each test No. and subjected to the torsion fatigue test. In the test specimen, its inner diameter was set at approximately 8.0 mm; the outer diameter of a restrained part 1a was set at 16 mm; the outer diameter of its center part 1b was set at 12 mm; and a load stress, represented by a stress at the outer surface of the center part 1b, was 550±375 MPa. The number of times to failure was measured as the durable number of times. For test specimens that did not lead to failure even after 10⁶ times, the test was stopped at that time. The smallest durable number of times among the durable numbers of times of the ten test specimens is shown as the durable number of times of each test No. in Table 3.

The measurement results of (1) to (4) are shown in Table 5 and FIG. 6. FIG. 6 is a graph showing the relationship between the maximum value of the uneven thickness ratio ever the entire length of the hollow seamless steel pipe and the durable number of times in the torsion fatigue test in inventive Examples of the present invention and Comparative Examples.

TABLE 5

| | | | | | Heating | | Measurement result of the thickness of | | | |
|---|---|---|---|---|---|---|---|---|---|---|
| | | | | | temperature | | the end part of the final pipe | | | |
| | | | Preheating | | before hot | Heating | Maximum | Minimum | Average | Uneven |
| | Steel | Manufacturing | temperature | Preheating | extrusion | time | thickness | thickness | thickness | thickness |
| No. | No. | condition | (° C.) | time (sec) | (° C.) | (sec) | (mm) | (mm) | (mm) | ratio (%) |
| 1 | A1 | A | 900 | 1,200 | 1,100 | 60 | 4.12 | 3.90 | 4.01 | 2.7 |
| 2 | A1 | B | 900 | 10 | 1,100 | 60 | 4.10 | 3.89 | 4.00 | 2.6 |
| 3 | A1 | B | 900 | 3,600 | 1,100 | 60 | 4.07 | 3.90 | 3.99 | 2.1 |
| 4 | A1 | C | — | — | 1,100 | 60 | 4.12 | 3.88 | 4.00 | 3.0 |
| 5 | A1 | D | — | — | 1,100 | 60 | 4.28 | 3.62 | 3.95 | 8.4 |
| 6 | A1 | E | — | — | 1,000 | 60 | 4.28 | 3.70 | 3.99 | 7.3 |
| 7 | A1 | F | — | — | 1,100 | 60 | 4.38 | 3.67 | 4.03 | 8.8 |
| 8 | A1 | G | — | — | — | — | 4.35 | 3.60 | 3.98 | 9.4 |
| 9 | A2 | A | 900 | 600 | 1,000 | 60 | 4.01 | 3.93 | 3.97 | 1.0 |
| 10 | A2 | A | 900 | 600 | 1,100 | 60 | 4.02 | 3.90 | 3.96 | 1.5 |
| 11 | A3 | A | 900 | 1,200 | 1,050 | 60 | 4.03 | 3.95 | 3.99 | 1.0 |
| 12 | A3 | A | 900 | 1,200 | 1,150 | 60 | 4.08 | 3.90 | 3.99 | 2.3 |
| 13 | A4 | A | 900 | 2400 | 1,000 | 60 | 4.03 | 3.99 | 4.01 | 0.5 |
| 14 | A4 | A | 900 | 2400 | 1,200 | 60 | 4.06 | 3.92 | 3.99 | 1.8 |
| 15 | A4 | B | 900 | 10 | 1,000 | 60 | 4.12 | 4.00 | 4.06 | 1.5 |
| 16 | A4 | B | 900 | 3,600 | 1,000 | 60 | 4.08 | 3.98 | 4.03 | 1.2 |
| 17 | A4 | C | — | — | 1,000 | 60 | 4.05 | 3.99 | 4.02 | 0.7 |
| 18 | A4 | D | — | — | 1,100 | 60 | 4.38 | 3.70 | 4.04 | 8.4 |
| 19 | A4 | E | — | — | 1,000 | 60 | 4.30 | 3.72 | 4.01 | 7.2 |
| 20 | A4 | F | — | — | 1,100 | 60 | 4.40 | 3.65 | 4.03 | 9.3 |
| 21 | A4 | G | — | — | — | — | 4.32 | 3.65 | 3.99 | 8.4 |
| 22 | A5 | A | 950 | 300 | 1,000 | 60 | 4.08 | 3.98 | 4.03 | 1.2 |
| 23 | A5 | A | 950 | 300 | 1,100 | 60 | 4.05 | 3.90 | 3.98 | 1.9 |
| 24 | A6 | A | 925 | 1,200 | 1,000 | 60 | 4.05 | 3.92 | 3.99 | 1.6 |
| 25 | A6 | A | 925 | 1,200 | 1,150 | 60 | 4.08 | 3.93 | 4.01 | 1.9 |
| 26 | A7 | A | 900 | 1,200 | 1,100 | 60 | 4.01 | 3.78 | 3.90 | 3.0 |
| 27 | A8 | A | 900 | 1,200 | 1,100 | 60 | 4.07 | 3.78 | 3.93 | 3.7 |
| 28 | A9 | A | 900 | 1,200 | 1,000 | 60 | 4.01 | 3.82 | 3.92 | 2.4 |
| 29 | A9 | A | 900 | 1,200 | 1,150 | 60 | 4.00 | 3.80 | 3.90 | 2.6 |
| 30 | A10 | A | 900 | 1,200 | 1,100 | 60 | 4.21 | 3.85 | 4.03 | 4.5 |

| | Measurement result of the thickness over | | | | | | |
|---|---|---|---|---|---|---|---|
| | the entire length of the final pipe | | | | | | |
| | | | (Maximum | Maximum | | | |
| | | | thickness + | value of | | | Durable number |
| | Maximum | Minimum | Minimum | uneven | Inner-surface | | of times in |
| | thickness | thickness | thickness)/2 | thickness | total | Inner-surface | torsion fatigue |
| No. | (mm) | (mm) | (mm) | ratio (%) | decarburization | flaw | test (times) |
| 1 | 4.17 | 3.86 | 4.02 | 3.9 | ∘ | ∘ | 510,000 |
| 2 | 4.30 | 3.73 | 4.02 | 7.1 | ∘ | ∘ | 46,000 |
| 3 | 4.15 | 3.85 | 4.00 | 3.8 | x | ∘ | 78,000 |
| 4 | 4.34 | 3.72 | 4.03 | 7.7 | ∘ | x | 50,000 |
| 5 | 4.30 | 3.60 | 3.95 | 8.9 | ∘ | x | 17,000 |
| 6 | 4.32 | 3.68 | 4.00 | 8.0 | ∘ | x | 16,000 |
| 7 | 4.38 | 3.65 | 4.02 | 9.1 | ∘ | x | 11,000 |
| 8 | 4.36 | 3.60 | 3.98 | 9.5 | ∘ | ∘ | 14,000 |
| 9 | 4.03 | 3.92 | 3.98 | 1.4 | ∘ | x | 42,000 |
| 10 | 4.07 | 3.90 | 3.99 | 2.1 | ∘ | ∘ | Stopped in one |
| | | | | | | | million times |
| 11 | 4.05 | 3.90 | 3.98 | 1.9 | ∘ | x | 91,000 |
| 12 | 4.09 | 3.88 | 3.99 | 2.6 | ∘ | ∘ | Stopped in one |
| | | | | | | | million times |
| 13 | 4.05 | 3.97 | 4.01 | 1.0 | ∘ | x | 59,000 |
| 14 | 4.07 | 3.94 | 4.01 | 1.6 | ∘ | ∘ | Stopped in one |
| | | | | | | | million times |
| 15 | 4.32 | 3.74 | 4.03 | 7.2 | ∘ | ∘ | 55,000 |
| 16 | 4.13 | 3.95 | 4.04 | 2.2 | x | x | 75,000 |
| 17 | 4.28 | 3.70 | 3.99 | 7.3 | ∘ | ∘ | 51,000 |
| 18 | 4.40 | 3.65 | 4.03 | 9.3 | ∘ | ∘ | 17,000 |
| 19 | 4.32 | 3.68 | 4.00 | 8.0 | ∘ | ∘ | 26,000 |
| 20 | 4.42 | 3.63 | 4.03 | 9.8 | ∘ | ∘ | 11,000 |
| 21 | 4.32 | 3.63 | 3.98 | 8.7 | ∘ | ∘ | 21,000 |
| 22 | 4.10 | 3.95 | 4.03 | 1.9 | ∘ | x | 63,000 |
| 23 | 4.10 | 3.93 | 4.02 | 2.1 | ∘ | ∘ | Stopped in one |
| | | | | | | | million times |
| 24 | 4.07 | 3.91 | 3.99 | 2.0 | ∘ | x | 41,000 |
| 25 | 4.09 | 3.90 | 4.00 | 2.4 | ∘ | ∘ | Stopped in one |
| | | | | | | | million times |
| 26 | 4.02 | 3.75 | 3.89 | 3.5 | ∘ | ∘ | 841,000 |
| 27 | 4.05 | 3.75 | 3.90 | 3.8 | ∘ | ∘ | 612,000 |
| 28 | 4.02 | 3.80 | 3.91 | 2.8 | ∘ | x | 31,000 |
| 29 | 4.05 | 3.78 | 3.92 | 3.4 | ∘ | ∘ | 625,000 |
| 30 | 4.24 | 3.85 | 4.05 | 4.8 | ∘ | ∘ | 477,000 |

Tests Nos. 1, 10, 12, 14, 23, 25 to 27, 29 and 30 shown in Table 3 having the uneven thickness ratio of 7.0% or less, the inner-surface flaw depth of 50 μm or less and the inner-surface total decarburization depth of 100 μm or less over the entire length of the steel pipe corresponded to circle marks in FIG. 6 and achieved 10⁵ or more times of the durable number of times in the torsion fatigue test. Thus, the results of these tests exhibited good durability. In particular, as the uneven thickness ratio becomes lower, the durable number of times tends to drastically increase. Each of tests Nos. 10, 12, 14, 23 and 25 having the uneven thickness ratio of 3.0% or less attained 10⁶ or more times of the durable number of times.

On the other hand, tests Nos. 2, 4 to 8, 15 and 17 to 21 having the uneven thickness ratio exceeding 7.0% corresponded to x marks in FIG. 6 and drastically reduced their durable numbers of times. Tests Nos. 3, 9, 11, 13, 16, 22, 24 and 28 having the uneven thickness ratio of 7.0% or less, but not satisfying the requirement of the present invention about at least one of the inner-surface total decarburization depth and the inner-surface flaw depth had low durable numbers of times, as illustrated by triangle marks in FIG. 5. Each of the steel pipes of tests Nos. 6 to 8 and 19 to 21, manufactured by any one of manufacturing conditions E to G in the prior art, resulted in the uneven thickness ratio exceeding 7.0%.

The present application claims priority to Japanese Patent Application No. 2015-001710 filed on Jan. 7, 2015, and Japanese Patent Application No. 2015-001711 filed on Jan. 7, 2015, the disclosures of the applications is incorporated herein by reference.

The present invention includes the following aspects.

### First Aspect:

A hollow seamless steel pipe for a spring according to a first aspect includes by mass %:

C: 0.2 to 0.7%;

Si: 0.5 to 3%;

Mn: 0.1 to 2%;

Cr: more than 0% and 3% or less;

Al: more than 0% and 0.1% or less;

P: more than 0% and 0.02% or less;

S: more than 0% and 0.02% or less;

N: more than 0% and 0.02% or less, with the balance being iron and inevitable impurities, wherein,

an uneven thickness ratio calculated by formula (1) below is 7.0% or less.

Uneven Thickness Ratio=(Maximum Thickness−Minimum Thickness)/(Average Thickness)/2×100 (1)

### Second Aspect:

The hollow seamless steel pipe for a spring according to the first aspect, wherein, over an entire length of the steel pipe, a maximum value of the uneven thickness ratio calculated by formula (2) below is 7.0% or less; an inner-surface flaw depth is 50 μm or less; and an inner-surface total decarburization depth is 100 μm or less.

Uneven Thickness Ratio=(Maximum Thickness−Minimum Thickness)/((Maximum Thickness+Minimum Thickness)/2)/2×100 (2)

### Third Aspect:

The hollow seamless steel pipe for a spring according to the first or second aspect, further including by mass %, B: more than 0% and 0.015% or less.

### Fourth Aspect:

The hollow seamless steel pipe for a spring according to any one of the first to third aspects, further including by mass %, one or more elements selected from a group consisting of V: more than 0% and 1% or less; Ti: more than 0% and 0.3% or less; and Nb: more than 0% and 0.3% or less.

### Fifth Aspect:

The hollow seamless steel pipe for a spring according to any one of the first to fourth aspects, further including by mass %, one or more elements selected from a group consisting of Ni: more than 0% and 3% or less; and Cu: more than 0%and 3% or less.

### Sixth Aspect:

The hollow seamless steel pipe for a spring according to any one of the first to fifth aspects, further including by mass %, Mo: more than 0% and 2% or less.

### Seventh Aspect:

The hollow seamless steel pipe for a spring according to any one of the first to sixth aspects, further including by mass %, one or more elements selected from a group consisting of Ca: more than 0% and 0.005% or less; Mg: more than 0% and 0.005% or less; and REM: more than 0% and 0.02% or less.

### Eighth Aspect:

The hollow seamless steel pipe for a spring according to any one of the first to seventh aspects, further including by mass %, one or more elements selected from a group consisting of Zr: more than 0% and 0.1% or less; Ta: more than 0% and 0.1% or less; and Hf: more than 0% and 0.1% or less.

### INDUSTRIAL APPLICABILITY

The use of the hollow seamless steel pipe in the present invention can manufacture a high-strength hollow spring that has high fatigue strength and excellent durability. For example, the present invention can be suitably used in springs that have a strength of 1,100 MPa or more, preferably 1,200 MPa or more, and even preferably 1,300 MPa or more. Thus, the present invention can promote hollowing or parts such as a suspension spring, a valve spring and a clutch spring, and thereby can further reduce the weight of vehicles such as automobiles, which is very useful in terms of industry.

### DESCRIPTION OF REFERENCE NUMERALS

1 Cylindrical test specimen
1a Restrained part
1b Center part
1c Cavity

1. A hollow seamless steel pipe for a spring, comprising by mass %:
C: 0.2 to 0.7%;
Si: 0.5 to 3%;
Mn: 0.1 to 2%;
Cr: more than 0% and 3% or less;
Al: more than 0% and 0.1% or less;
P: more than 0% and 0.02% or less;
S: more than 0% and 0.02% or less;
N: more than 0% and 0.02% or less; and iron,
wherein an uneven thickness ratio calculated by formula (1) is 7.0% or less;
Uneven Thickness Ratio=(Maximum Thickness−Minimum Thickness)/Average Thickness)/2×100 (1).

2. The hollow seamless steel pipe for a spring according to claim 1, wherein, over an entire length of the steel pipe, a maximum value of the uneven thickness ratio calculated by formula (2) is 7.0% or less; an inner-surface flaw depth is 50 μm or less; and an inner-surface total decarburization depth is 100 μor less;
Uneven Thickness Ratio=(Maximum Thickness−Minimum Thickness)/((Maximum Thickness+Minimum Thickness)/2)2×100 (2)

3. The hollow seamless steel pipe for a spring according to claim 1, further comprising by mass %, at least one of the following (a) to (f)
(a) B: more than 0% and 0.015% or less;
(b) one or more elements selected from a group consisting of V: more than 0% and 1% or less, Ti: more than 0% and 0.3% or less; and Nb: more than 0% and 0.3% or less;
(c) one or more elements selected from a group consisting of Ni: more than 0% and 3% or less; and Cu: more than 0% and 3% or less;
(d) Mo: more than 0% and 2% or less;
(e) one or more elements selected from a group consisting of Ca: more than 0% and 0.005% or less, Mg: more than 0% and 0.005% or less; and REM: more than and 0% and 0.02% or less; and
(f) one or more elements selected from a group consisting of Zr: more than 0% and 0.1% or less; Ta: more than 0% and 0.1% or less; and Hf: more than 0% and 0.1% or less.

4-8. (canceled)
